(19) United States
(12) Patent Application Publication
(10) Pub. No.: US 2004/0039459 A1
(43) Pub. Date: Feb. 26, 2004

(54) Universal device control

(76) Inventors: Paul R. Daugherty, Maplewood, NJ (US); Chad E. Burkey, Palo Alto, CA (US)

Correspondence Address: VEDDER PRICE/ACCENTURE, 222 NORTH LASALLE STREET, CHICAGO, IL, 60601, US

(21) Appl. No.: 10/213,722

(22) Filed: Aug. 6, 2002

(51) Int. Cl. G05B 11/01; G05B 13/02

(52) U.S. Cl. 700/39; 700/17; 700/19

(57) ABSTRACT

A system and corresponding method for independently controlling a plurality of manufacturer specific devices through a generic interface is disclosed. The system includes a translation layer operative to convert signals from a plurality of nodes into a normalized signal; and a node abstraction layer, operatively coupled to the translation layer, for receiving the normalized signal and to transmit a generic control signal in response to the normalized signal. The node abstraction module includes a generic object model of most types of home automation devices, sensors and actuators, which provides for independent control of the plurality of manufacturer specific devices.

### FIELD OF THE INVENTION

The present invention generally relates to home automation technology and, more particularly, to a system and method for universally monitoring and controlling a plurality of devices.

### BACKGROUND OF THE INVENTION

Today's modem homes include a plurality of home automation devices that are powered by electricity and function according to their own specific software protocols. Examples of such devices include stoves, motion sensors and thermostats that maintain the temperature of one or more rooms at a selected temperature based on a specific schedule. An example of a combination function is turning lights on/off based on whether there is motion detected in a given room.

As there may be several manufacturers of each of the aforementioned and additional types of devices, there are many brands of home automaton devices to choose from. Oftentimes, these devices are controlled by proprietary software that is only compatible with devices or brands provided by the same manufacturer. Thus, it is possible for a home, or other structure to have, for example, a thermostat or motion sensor manufactured by manufacturer A in one room and a thermostat or motion sensor manufactured by manufacturer B in a second room thereof. As the devices are manufactured by different manufacturers, they may operate according to different proprietary software. As inter-manufacturer software is often incompatible, the aforementioned devices must be separately monitored and controlled.

A drawback associated with using a plurality of devices from different manufacturers is that when you add an additional device (or upgrade) to a room of the structure, the proprietary software associated with the device must be added to the larger control mechanism of the structure. For example, if you add a refrigerator manufactured by manufacturer D to a structure having no other devices manufactured by that particular manufacturer, the proprietary software associated with the refrigerator must be added to the control mechanism of the structure. This, oftentimes, requires the control mechanism to be completely overhauled. This is an acute problem when the several devices present in a structure are of a first brand and the newly added device is of a second brand. As the control mechanism is often a custom mechanism, adding an incompatible device will require the control mechanism to be completely redesigned.

An associated problem with using incompatible devices is that it locks the user into a particular type of device or manufacturer. That may result in a tremendous amount of back end expenditures if the manufacturer goes out of business or leaves the particular device market.

In addition to the compatibility issues outlined above, being restricted to communicating and controlling devices only through the accompanying proprietary software results in an overall reduction in energy efficiency. For example, if a device such as a refrigerator that uses continuous amounts of electricity malfunctions, it can only be turned off either manually at the source or through the proprietary software. As a result, if the malfunction occurs while no one is monitoring the device, a tremendous amount of electricity may be wasted. In those parts of the world where electricity availability and transmission are limited, wasting electricity on malfunctioning devices can be tremendously burdensome to already limited resources.

Thus, there is a need for a universal mechanism that is capable of communicating with and controlling a plurality of devices across a plurality of formats and structures.

### SUMMARY OF THE INVENTION

Briefly stated, the present invention is directed to a system that allows any operating software to independently interact with any suitable device within a structure using a standard interface. This allows for single entity monitoring and/or control of a plurality of devices, each having its own specific operating parameters or software. In an exemplary embodiment, the system of the present invention is a provided as a software tool, including a generic object model of most types of household devices, sensors and actuators, which provides for independent access and control of the aforementioned devices. Actuator or device control is provided through a standard interface, referred to as a Node Abstraction Layer (NAL). The NAL receives normalized signals from a plurality of different types of devices and transmits signals thereto operative to control each of plurality of devices independently of proprietary software that may be associated therewith.

A translation layer is coupled to the NAL and is operative to convert device-specific information signals into the normalized signals that are transmitted to the generic object model maintained within the NAL. This model, in turn, sends the normalized signals to any appropriate monitoring or control software. Because the NAL is a generic interface, the monitoring or control software does not perceive the incoming signals as originating from a particular, and potentially, incompatible device. Thus, by using the NAL of the present invention, a single entity can monitor and control the several devices, manufactured by different entities, present within a structure.

Through modeling of the information provided by the NAL, use or operating patterns can be developed which result in the structure becoming more energy efficient. In similar fashion, by increasing energy efficiency within a structure, overall energy usage efficiency and distribution will be positively effected.

### BRIEF DESCRIPTION OF THE DRAWINGS

The present invention and the associated advantages and features provided thereby will become best understood and appreciated upon review of the following detailed description of the invention, taken in conjunction with the following drawings, where like elements represent like elements, in which:

FIG. 1 is a schematic representation of a structure including a plurality of devices provided by different manufacturers;

FIG. 2 is a schematic block diagram of the components of a monitoring station maintained within the structure illustrated in FIG. 1;

FIG. 3 is a schematic block diagram of the monitoring and control system according to the present invention;

FIG. 4 is a flow chart illustrating the operations performed by the monitoring and control system illustrated in FIG. 3; and

FIG. 5 is a schematic block diagram of a community interconnected to a system integrator employing the monitoring and control system according to the present invention.

### DETAILED DESCRIPTION OF THE INVENTION

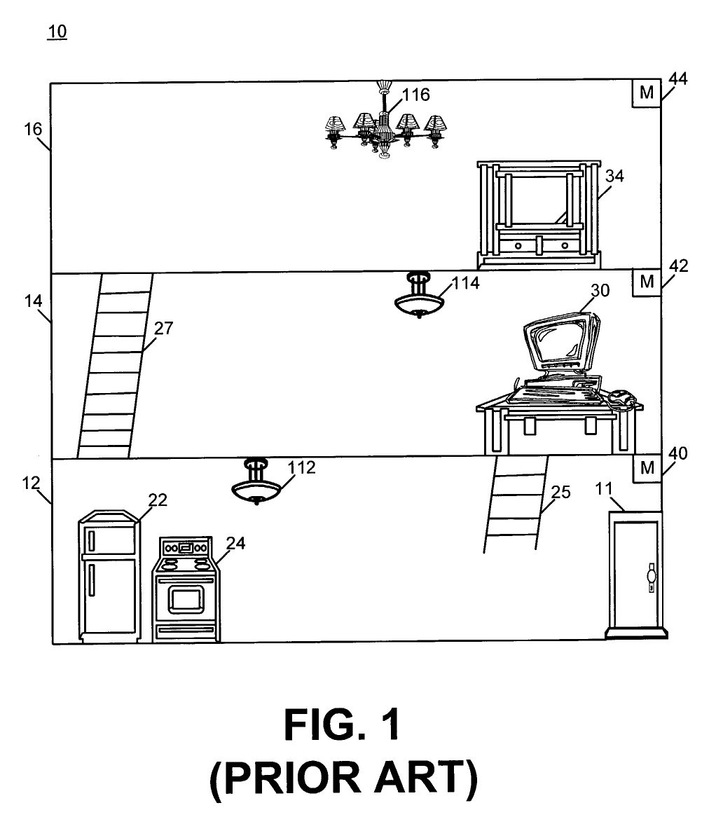

An exemplary embodiment of the present invention will now be described with reference to FIGS. 1-5, in conjunction with the monitoring and control of motion sensors within a structure. Referring now to FIG. 1, illustrated therein is a structure 10 having a plurality of floors 12, 14 and 16. Each of the floors includes a node with at least one electrically powered device coupled thereto. In particular, structure 10 is a three-story house where on the first floor 12 there is maintained a refrigerator 22, an oven 24, a motion sensor 40 and a light source 112, each coupled to a corresponding node. For purposes of illustration and example, each of the electrically powered devices located on the first floor is manufactured by manufacturer A. A door 11 provides a point of ingress/egress to the house 10. Staircase 25 provides a point of access to the second floor 14 of the house 10.

On the second floor 14 is a control station 30 embodied, in an exemplary embodiment, within a computer, a second motion sensor 42 and a second light source 114. The control station 30, motion sensor 42 and light source 114 are also coupled to their respective nodes. However, in an alternate embodiment, the several devices can be coupled to a single node. The motion sensor 42 for the second floor is manufactured by manufacturer B. Staircase 27 provides access to the third floor 16 of the house 10.

On the third floor is an entertainment center 34, a third motion sensor 44 and a third light source 116. In the exemplary embodiment, the third motion sensor 44 is manufactured by manufacturer C. As shown, the house 10 includes at least one motion sensor 40-44 on each floor. As is known, the purpose of the motion sensors is to detect movement within the boundary of the particular area being scanned by the motion sensor. The motion sensor provides a beam of radiation, across an area matrix to detect motion. When one of the beams of radiation is broken, the motion sensor detects such break and, based on programming, generates a specified signal. The particular signal generated by each of the individual motion sensors 40-44 is manufacturer dependent, and is based on the proprietary software and/or microcode that is used to control the operation of the motion sensors.

Compound functions are one type of function initiated by the motion sensors. For example, the motion sensors 40-44 may be coupled to one of the light sources 112-116 and control whether such light sources 112-116 are turned on/off based on the detection of movement within a given area. More specifically, the motion sensors 40-44 may be coupled to a respective one of the light sources 112-116 and correspondingly configured to cause a respective light to turn on if motion is detected within the area. Alternately, if no motion is detected within the monitored area, or if one of the radiation beams is not triggered within a specified time period, the light associated with a given motion sensor is turned off. The turning on/off of the respective light source by the corresponding motion sensor is controlled by the proprietary software of the particular manufacturer.

As manufacturers compete with one another for market share and product capability, the competing products are generally not compatible with one another. Thus, motion sensor 40 manufactured by manufacturer A will not be compatible with motion sensor 42, manufactured by manufacturer B. Likewise, motion sensor 44 manufactured by manufacturer C will not be compatible with either motion sensors 40 or 42. Thus, in situations where coordination of devices and communication is critical, the plurality of incompatible devices will be of little use as they are not compatible with one another. The ramifications of using incompatible devices can be illustrated in the situation where a monitoring station (e.g. a security provider) is responsible for monitoring a plurality of homes, each having sensors provided by a different manufacturer.

In the situation, for example, where houses one and two of three, experience an alarm-triggering event, the monitoring station has to be able to communicate with at least two different protocols to detect the event and provide the appropriate response. This is not overly burdensome when there are a small number of houses, and correspondingly small number of detection devices. However, such is not the case when the service provider is responsible for monitoring many, many houses. Having to maintain a database of an unknown number of protocols can quickly overburden the system. The present invention eliminates such burdens by providing a software tool that provides the ability to communicate with and control a plurality of devices independent of the heretofore incompatible protocols associated with competing manufacturers.

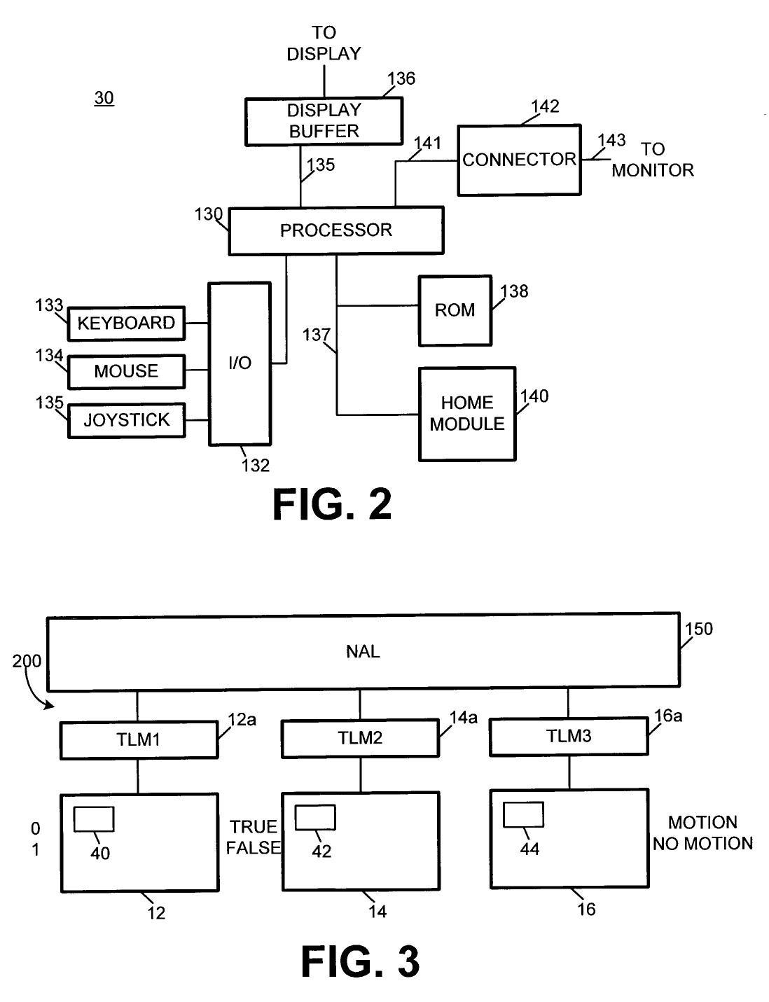

Referring now to FIG. 2, illustrated therein is a schematic block diagram of the monitoring and control station 30. As shown, the monitoring and control station 30 is a computing device employing a processor 130. The processor 130 is coupled to an I/O port 132, which in turn is coupled to a plurality of input devices (e.g. keyboard 133, mouse 134 and joy stick 135). The processor 130 is also coupled to a permanent memory 138 and a household specific storage memory module 140 through bus 137; a display buffer 136 through video bus 135; and a connector module 142 via bus 141. The permanent memory 138 may contain, for example, a portion of the operating code that is executed by the processor 130. The connector module 142 is adapted to connect to an outside resource such as, for example, a monitoring/security provider via bus 143. Other components may be connected to the I/O port, and form part of the computer monitoring system 30. The storage memory module 140 stores the monitoring and control software, as executed by the processor 130, of the present invention as will be described in greater detail below with reference to FIGS. 3-5.

Referring now to FIG. 3, illustrated therein is a schematic block diagram of the plurality of motion sensors 40-44 of the house 10 and their interconnection (i.e. signals) to the monitoring and control system 200 of the present invention. As discussed above, each of the motion sensors 40-44 is manufactured by a different manufacturer; thus, the motion sensors 40-44 cannot communicate with one another or seamlessly to a third party entity or service as the motion sensors employ incompatible protocols, as presented in Table 1.

TABLE 1

| Manufacturer | ON | OFF |
|---|---|---|
| A (40) | 1 | 0 |
| B (42) | TRUE | FALSE |
| C (44) | MOTION | NO MOTION |

More specifically, motion sensor 40 manufactured by manufacturer A employs a protocol where detected motion is represented by a logical “1” signal and no detected motion is represented by a logical “0” signal; motion sensor 42 manufactured by manufacturer B employs a protocol where detected motion is represented by a “TRUE” signal and no detected motion is represented by a “FALSE” signal; and motion sensor 44 manufactured by manufacturer C employs a protocol where detected motion is represented by a “MOTION” signal and no detected motion is represented by a “NO MOTION” signal.

Each of the motion sensors 40-44, in turn, is coupled to a respective translation layer module 12a-16a that is responsible for converting the manufacturer specific signals as provided in Table 1 to a normalized control signal. In an exemplary embodiment, the translation layer modules 12a-16a of the present invention are implemented as a software module. More specifically, motion sensor 40 is coupled to translation layer module (TLM 1) 12a; motion sensor 42 is coupled to corresponding translation layer module (TLM 2) 14a; and motion sensor 44 is coupled to corresponding translation layer module (TLM 3) 16a. The function of the translation layer 12a-16a is to map the manufacturer specific operating representations (i.e. signals) into a normalized control signal that is transmitted to a Node Abstraction Layer (NAL) 150 for processing. For purposes of illustration and example, the normalized control signal acknowledged by the NAL 150 as representing detected motion is a logical “1” signal; and no detected motion is represented as a logical “0” signal. Each of the translation layer modules 12a-16a may also be implemented in hardware or a combination of hardware and software. Although illustrated as separate modules that individually pass the normalized signal to the NAL 150, the translation layer modules 12a-16a can be implemented as a single layer, capable of transmitting one or a plurality of normalized signals from the motion sensors 40-44 to the NAL 150.

The NAL 150 is a software module that contains a generic object model of substantially every type of household device, sensor and actuator. The NAL 150 may also be implemented in hardware or a combination of hardware and software. In an exemplary embodiment, the NAL 150 of the present invention contains a generic model that emulates the operation of each of the plurality of motion sensors 40-44 and the differences in the operating characteristics therebetween. The NAL 150 is stored, at least in part, in the home storage memory module 140 of the control station 30 (FIG. 2). Through the NAL 150, any third party or system integration software (i.e. monitoring and control software) can interact with any electrically powered device within a structure using the standard interface 142. Stated another way, the NAL 150 abstracts the attributes of each device, sensor and actuator to a set of normalized attributes such that all components (e.g. motion sensor) of a specific structure can be monitored and controlled through a consistent, generic interface regardless of manufacturer.

By employing the NAL 150, the universal monitoring and control system 200 of the present invention can be efficiently and easily maintained within a corresponding structure as the intricacies and myriad specifications and protocols associated with the plurality of device manufacturers to communicate and control their respective devices do not have to be maintained or accounted for. In this manner, upgrading the system or adding to or removing a device from a structure becomes straightforward. Instead of having to reconfigure, or even redesign the structure monitoring software to account for the protocols of a new component, as is required in existing technologies, the NAL 150 of the present invention is not altered. The translation layer module 12a-16a interfaced with the new device is modified slightly to account for the new device. Modifying a specific translation layer module 12a-16a is easier and more economical than having to alter or otherwise reconfigure the NAL 150.

In addition to the relative ease of modifying or updating the monitoring and control system 200 of the present invention, compatibility issues associated with the several device manufacturers are also negated. As the NAL 150 employs a generic, object device model and global interface that receives and sends signals only through the translation layer 12a-16a, manufacturer specific protocols for monitoring and controlling the several devices within the structure are not required. The compatibility issues associated with different manufacturers protocols are overcome. In this manner, the NAL 150 provides for independence between software services and specific manufacturer devices.

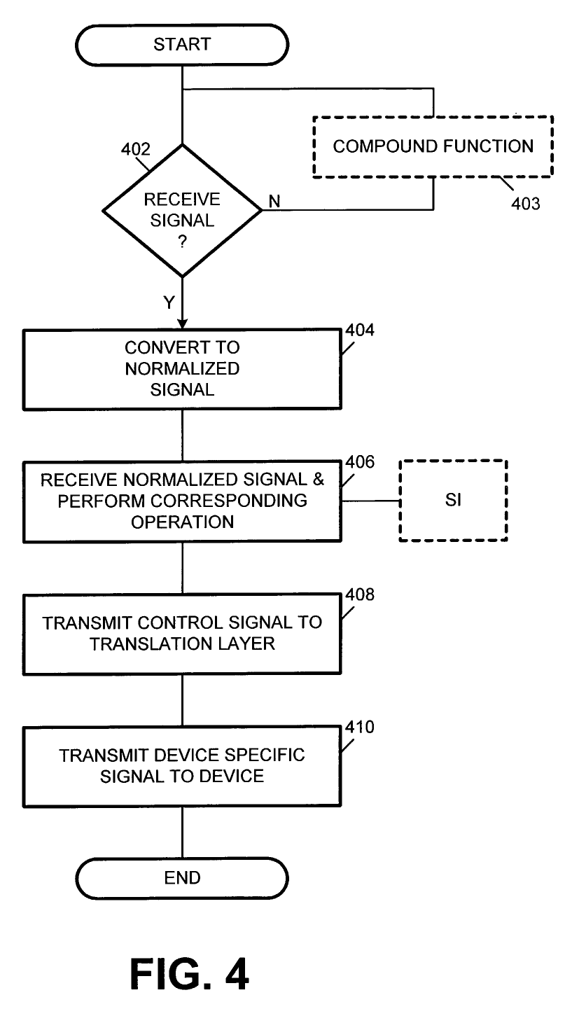

Referring now to FIG. 4, the steps performed by the translation layer 12a-16a and the NAL 150 of the monitoring and control system 200 when monitoring and controlling a plurality of motion sensors will be described. The process begins at step 402 where the translation layer determines whether a signal from a corresponding motion sensor has been received. If no signal has been received, indicating no motion has been detected in the corresponding floor, the translation layer waits for a signal. In an alternate embodiment (shown within dotted lines), if a signal is not received, a predetermined function such as turning off the light source 112-116 on the associated floor is performed. On the other hand, if a signal is received, for example, from motion sensor 44 the manufacturer specific signal (e.g. MOTION) is converted into a normalized signal (i.e. 1) by the translation layer in step 404. The normalized signal is transmitted to the NAL for processing.

In step 406, the NAL receives the normalized signal and performs the corresponding operation thereon based on the generic operation parameters maintained within the NAL. For example, the operation may be to turn on the associated light source 116 or notify a third party integrator (i.e. security monitoring service) that motion has been detected within the structure. Notifying the third party integrator of receipt of a detected signal from the motion sensor 44 is performed by contacting the same through connector 142 (FIG. 2) via bus 143, which is represented by the dashed box labeled “SI”.

In the situation where the light source 116 is to be turned on (e.g. activated) upon the motion sensor detecting motion, the generic control signal to initiate such operation is transmitted to the appropriate translation layer for conversion into the manufacturer specific signal in step 408. The manufacturer specific control signal to turn on the light source 116 is transmitted thereto in step 410.

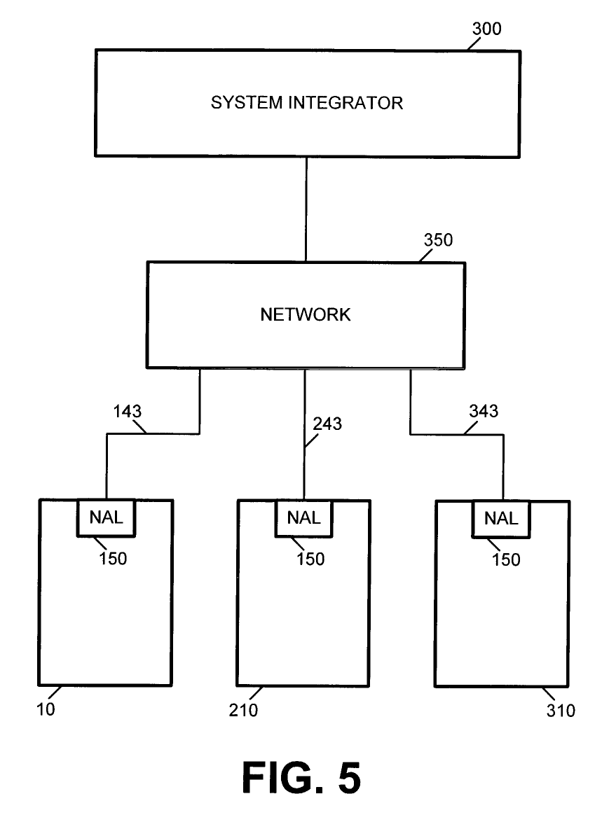

As illustrated above, the device control system of the present is capable of monitoring and controlling a plurality of otherwise incompatible devices from several manufacturers through a generic interface. By employing a translation layer and an abstraction of device operation, the system of the present invention can control a plurality of devices independent of the particular protocols or nomenclature associated with the manufacturer of the several devices. Thus, the monitoring and control of such devices is decoupled from the proprietary software associated with the manufacturer of such devices. In this fashion, it is possible to transfer the monitoring and control functions of the devices within a structure to a third party service integrator which can bundle such monitoring and control services with other services to provide enhanced capabilities and economies of scale. For example, an electrical utility can act as system integrator for structures in a given area and develop an electricity use model based on the NAL. Such a system is illustrated in FIG. 5.

As shown in FIG. 5, the system integrator 300 is connected to a plurality of structures 10, 210 and 310 via a network connection 350. The several structures 10, 210 and 310 are coupled to the network connection 350 through their respective connectors 142 (FIG. 2). More specifically, structure 10 is connected to the network connection 350 through line 143; structure 210 is connected to the network connection 350 through line 243; and structure 310 is connected to the network connection 350 through line 343. Each of the transmission lines 143, 243 and 343 carries the signal provided by the corresponding NAL 150 when performing, for example, step 406 as discussed above with respect to FIG. 4.

In exemplary fashion, if system integrator 300 is an electrical utility, the utility can modify the amount of electricity transmitted to a given structure based on the actual use patterns associated with the structure. In other words, based on the information provided to the utility 300 by the individual structures 10, 210 and 310, electricity use patterns can be developed which may result in the reallocation of electricity between the structures based on consumption; thereby conserving the amount of energy generated and transmitted to a given locale. This will provide for elasticity in electricity pricing based on actual use as unnecessary electricity generation and transmission will be negated. Other services can also be integrated with the monitoring and control software of the present invention. For example, meter reading from remote locations is also possible. In this fashion, structures located in remote or hard to access areas may receive the benefits associated with elastic pricing based on actual use.

The above detailed description of the present invention and the examples described therein have been provided for the purposes of illustration and description. Although an exemplary embodiment of the present invention has been described in detail herein with reference to the accompanying drawings, it is to be understood that the present invention is not limited to the precise embodiment disclosed, and that various changes and modification to the invention are possible in light of the above teaching. Accordingly, the scope of the present invention is to be defined by the claims appended hereto.

What is claimed is:

1. A system, comprising:
a translation layer operative to convert signals from a plurality of nodes into a normalized signal; and
a node abstraction layer, operatively coupled to the translation layer, for receiving the normalized signal, and to transmit a generic control signal in response to the normalized signal.

2. The system of claim 1, further including a control station, operative to provide access to the node abstraction layer.

3. The system of claim 1, wherein the translation layer further comprises a plurality of translation layer modules, each coupled to a plurality of individual nodes.

4. The system of claim 1, wherein each of the plurality of nodes includes at least one electrically powered device coupled thereto.

5. The system of claim 5, wherein each of the at least one electrically powered devices actuates between an on state and an off state.

6. The system of claim 5, wherein the associated on state and off state of the at least one electrically powered device corresponds to a specific signal type which is converted into a normalized control signal by the translation layer.

7. The system of claim 1, wherein the node abstraction layer provides a generic operating model which emulates the devices coupled to each of the plurality of nodes.

8. The system of claim 1, wherein the node abstraction layer can be accessed by an outside resource.

9. A system for controlling a plurality of devices, comprising:
a plurality of translation layer modules operative to convert a signal from a corresponding node into a normalized signal; and
a node abstraction layer, coupled to the plurality of translation layer modules, operative to provide a control signal to a respective node, the node abstraction layer including a generic object model which provides the control signal in response to the normalized signal.

10. A method for controlling a plurality of devices, comprising:
receiving a signal, the signal representing the current state of a device coupled to a corresponding node;
converting the received signal into a normalized signal;
generating at least one control signal in response to the normalized signal, the at least one control signal based on a generic object model; and
transmitting the at least one control signal to the node.

11. The method of step 10, further including:
receiving a modified control signal from the generic object model and transmitting the modified control to the node.

12. The method of claim 10, wherein the transmission of the normalized signal is performed independent of the corresponding node.

13. A device control system, comprising:
a processor; and
a memory, coupled to the processor, the memory including instructions that, when executed by the processor, cause the processor to:
receive signals from a plurality of nodes, the signals representing a current state of each of the plurality of nodes;
converting each of the received signals into a corresponding normalized signal based on a generic model maintained in the memory;
converting the normalized signal into a control signal based in part on the generic model maintained in the memory; and
transmitting the control signal to at least one of the plurality of nodes to modify the state of the respective node.

14. The device control system of claim 13, further including means for connecting the processor to an outside resource, the outside resource performing a regulatory operation in response to the control signal.

15. The device control system of claim 13, wherein each of the plurality of nodes has at least one device coupled thereto, the corresponding control signal operative to control the operation of the at least one device.
